(19) United States
(12) Patent Application Publication
(10) Pub. No.: US 2024/0239454 A1
(43) Pub. Date: Jul. 18, 2024

(54) METHOD OF ASSEMBLING A VESSEL OVERBOARD DISCHARGE ASSEMBLY

(71) Applicant: Maersk A/S, Copenhagen K (DK)

(72) Inventors: Jorn KAHLE, Copenhagen K (DK); Toby AUSTIN-FRASER, Copenhagen K (DK)

(21) Appl. No.: 18/561,519

(22) PCT Filed: May 27, 2022
(86) PCT No.: PCT/EP2022/064480

§ 371 Date: Nov. 16, 2023

(30) Foreign Application Priority Data
May 28, 2021 (DK) PA202100570

(51) Int. Cl. B63B 81/00; B01D 53/18; B01D 53/50; F16L 7/02; F16L 55/165; F16L 58/10

(52) U.S. Cl. CPC B63B 81/00; F16L 7/02; F16L 55/1657; F16L 58/1036; B01D 53/18; B01D 53/50; B01D 2252/103; B01D 2257/302; B01D 2259/4566; B63B 2221/10

(57) ABSTRACT

Disclosed is a method (200) of assembling a vessel overboard discharge assembly (600), the method (200) comprising: inserting (210) a tubular insert (500) into an overboard discharge pipe (300) so that a space (400) is defined between the tubular insert (500) and the overboard discharge pipe (300): blocking (221) an outboard opening (401) into the space (400) at an outboard end (301) of the space (400): and providing (280) in the space (400) an adhesive (450) and/or chocking material (450) for adhering and/or chocking the tubular insert (500) in the overboard discharge pipe (300).

### TECHNICAL FIELD

The present invention relates to methods of assembling vessel overboard discharge assemblies, such as vessel scrubber outlet assemblies, to vessel overboard discharge assemblies, to tubular inserts for overboard outlet pipes, to kits of parts for use in repairing or providing overboard discharge outlets of vessels; and to vessels comprising overboard discharge assemblies.

### BACKGROUND

Marine vessels, such as container ships, have engines that are powered by heavy fuel oil (HFO) or the like. Such fuel contains sulphur which, following combustion in an engine of the marine vessel, forms sulphur oxides (SOx), which are emitted into the atmosphere as exhaust gas emissions.

Since 2005, the United Nations shipping agency, the International Maritime Organisation (IMO), has implemented global regulations to limit the amount of SOx, and other exhaust gases, emitted from the engines of marine vessels. In 2020, the IMO regulations were updated to restrict marine vessels to the use of fuels having a maximum sulphur content of 0.5%, down from 3.5% in previous years. Some marine vessels have exhaust gas cleaning systems (EGCS), or “scrubbers”, installed to meet exhaust gas SOx limits set by the IMO. Marine vessels installed with scrubbers may use fuels which have a sulphur content higher than the limit set by the IMO, such as HFO or the like.

Scrubbers are installed in exhaust gas systems of marine vessels to remove SOx and other particulate matter from the exhaust gases of engines or boilers of the marine vessels. Wet scrubbers and dry scrubbers are known in the art. In each case, an exhaust gas is exposed to an alkaline scrubbing material to neutralise the exhaust gas, which is acidic, and to remove any impurities in the exhaust gas. In wet scrubbers, water, or another suitable fluid, is sprayed into the exhaust gas stream to remove SOx from the exhaust gas stream. In dry scrubbers, a dry reagent, such as limes, is sprayed into the exhaust gas stream for the same purpose, or the exhaust gas stream is passed through the dry reagent.

Wet scrubbers installed on marine vessels typically use either fresh water or sea water as the scrubbing reagent. In some cases, additives such as caustic soda (sodium hydroxide, NaOH) and limestone (calcium carbonate, CaCO3) are added to the water. In open-loop scrubbers, sea water is used as the scrubbing reagent, which is sprayed into an exhaust gas stream to convert SOx to sulphates or sulphuric acid, and the effluent from the scrubber, also known as “washwater”, is discharged into the sea. The washwater is thus an acidic, high-temperature effluent, which poses a risk of damage to pipework at scrubber outlets, primarily due to corrosion. In some cases, particularly on larger marine vessels, a diffuser is required at the scrubber outlet to increase a level of mixing of washwater with surrounding sea water, thereby to neutralise the washwater as it is discharged into the ocean.

It is known to provide a corrosion-resistant coating to mitigate damage to the pipework. In one known solution, a scrubber outlet pipe and a diffuser are made from the same corrosion-resistant material, specifically austenitic stainless-steel. The diffuser is welded into the pipe and the weld is coated with a corrosion-resistant coating, such as a vinyl ester coating.

A risk of corrosion may still be present, however, such as at the weld, or other locations where there may be an impurity in the coating. This can lead to gaps or weaknesses in the coating, exposing the underlying material to the corrosive washwater. Moreover, there may be a risk of galvanic corrosion between the stainless-steel pipe and a mild steel hull of the marine vessel to which it is coupled.

Other overboard discharge pipes of overboard discharge outlets of vessels, such as ballast water discharge pipes, may be similarly susceptible to corrosion in the presence of seawater or other material discharged therethrough.

In many cases, it is necessary to repair a corroded vessel overboard discharge assembly or pipe, such as a marine vessel scrubber outlet assembly or pipe. This may involve replacing a section of the assembly, pipe and/or hull, such as by dry-docking the vessel, or by creating a positive pressure enclosure, or “habitat”, around the overboard discharge area, which can be costly, difficult and time-consuming.

Embodiments of the present invention aim to reduce a risk of corrosion of overboard discharge pipework, and to improve a repair of corroded overboard discharge outlets, while addressing the aforementioned problems.

### SUMMARY

According to a first aspect of the present invention, there is provided a method of assembling a vessel overboard discharge assembly, the method comprising: inserting a tubular insert into an overboard discharge pipe so that a space is defined between the tubular insert and the overboard discharge pipe; blocking an outboard opening into the space at an outboard end of the space; and providing in the space an adhesive and/or chocking material for adhering and/or chocking the tubular insert in the overboard discharge pipe.

In this way, the tubular insert may be easily and reliably secured in the overboard discharge pipe, such as without requiring screws, clasps, or other fasteners.

Optionally, the tubular insert defines a flow path for overboard discharge from the vessel. Optionally, the vessel overboard discharge assembly is a scrubber outlet assembly, and the overboard discharge pipe is a scrubber outlet pipe.

Optionally, the space extends circumferentially around the tubular insert. In this way, providing adhesive and/or chocking material in the space may improve a level of support and/or alignment of the tubular insert in the overboard discharge pipe.

The adhesive and/or chocking material may be resilient to thermal and/or physical shock. In this way, providing adhesive and/or chocking material in the space may provide a more reliable bond between the tube and the pipe in harsh conditions, as may be present in use on a vessel, such as a marine vessel.

Optionally, the tubular insert comprises a tube and one or more protrusions at an outer surface of the tube. The, or each, protrusion may help to align the tube within the overboard discharge pipe, such as centrally within the overboard discharge pipe, to define the space between the tubular insert and the overboard discharge pipe.

The, or each, protrusion may be a raised portion of the outer surface of the tube. That is, the, or each, protrusion may be integral with other portions of, or the rest of, the tube. Optionally, the, or each, protrusion is a discrete part provided on the outer surface of the tube, such as by bonding to the outer surface of the tube. Optionally, the, or each, protrusion is an elongate protrusion extending circumferentially or longitudinally along at least a part of the outer surface of the tube. The, or each, protrusion may extend along a full circumference or length of the tube, or may extend only partially along the full circumference or length of the tube. In other examples, the, or each, protrusion is arranged at the outer surface of the tube in any other suitable way.

Optionally, the inserting comprises inserting the tubular insert into the overboard discharge pipe from an outboard end of the overboard discharge pipe.

This may improve an ease of insertion of the tubular insert into the overboard discharge pipe. For instance, it may be possible for components at an inboard end of the pipe to remain in place during assembly. That is, no or fewer components may need to be removed from the inboard end to allow the tubular insert to be inserted into the overboard discharge pipe. This is particularly advantageous where the components at the inboard end include components that would be difficult to remove and/or re-install, such as a length of rigid pipe that would need to be cut. This is also advantageous where there is limited space surrounding the inboard end for manoeuvring the tubular insert and/or for locating installation personnel, as may be the case on a vessel, such as a marine vessel.

Optionally, the blocking occurs after the inserting.

Optionally, the method comprises blocking the outboard end of the overboard discharge pipe, and the blocking the outboard end of the overboard discharge pipe comprises the blocking the outboard opening into the space. For example, the method may comprise using a cover to block the outboard end of the overboard discharge pipe in such a way that the cover blocks the outboard opening into the space at the outboard end of the space. Optionally, at least a portion of the cover is flexible, or resilient, so that the cover better conforms to the outboard end of the overboard discharge pipe and/or to the outboard opening into the space. Optionally, the method comprises using a cover jig to locate and/or secure the cover in place. Optionally, the cover jig comprises a portion secured at an inboard end of the overboard discharge assembly. In this way, the cover may be easily manipulated, such as secured and/or at least partially detached, from the inboard end.

Optionally, the inserting is performed when the outboard end of the overboard discharge pipe is submerged. Accordingly, the vessel need not be put into dry dock to perform the method, meaning that the vessel can return to full service more promptly after completion of the method. Optionally, the method comprises using one or more flotation devices to increase a buoyancy of the tubular insert during the inserting of the tubular insert. This may help a person inserting the tubular insert to manhandle the tubular insert. Optionally, a buoyancy of the one or more flotation devices is adjustable, such as to allow the tubular insert to be more easily manoeuvred when fully and/or partially submerged.

Optionally, the method comprises at least partially, e.g. fully or only partially, draining the space or the overboard discharge pipe after the blocking the outboard end of the overboard discharge pipe. Advantageously, this permits more complete filling of the space with the adhesive and/or chocking material and thus potentially better adhesion and/or chocking of the tubular insert in the overboard discharge pipe. Moreover, otherwise providing the adhesive and/or chocking material in the space when the space is at least partially undrained could result in the adhesive and/or chocking material being detrimentally diluted.

Optionally, the method comprises blocking an inboard opening into the space at an inboard end of the space. Optionally, the blocking the inboard opening comprises applying a glue and/or a putty to block the inboard opening. Optionally, the method comprises providing a vent hole to allow air and/or adhesive and/or chocking material to be vented when providing the adhesive and/or chocking material in the space. Providing such a vent hole may limit an occurrence of air pockets in the adhesive and/or chocking material, providing a more reliable bond or retention of the tubular insert in the overboard discharge pipe.

Optionally, the vent hole is located at an upper end of the space. Optionally, the method comprises filling the space with the adhesive and/or chocking material until the adhesive and/or chocking material enters and/or is expelled through the vent hole. In this way, by providing the vent hole at an upper end of the space, it is possible to achieve a visual indication that the adhesive and/or chocking material has filled, or substantially filled, the space. Optionally, the providing the vent hole comprises forming, such as cutting, drilling, or grinding, a groove at an inboard end of the overboard discharge pipe, such as in a flange at the inboard end. Optionally, the vent hole is a first vent hole that is at least partially defined by the groove. Optionally, the groove extends from an interior surface of the overboard discharge pipe to an outer surface of the flange. Optionally, the method comprises providing a second vent hole in the material blocking the inboard opening.

Optionally, the method further comprises unblocking the outboard opening into the space after the providing adhesive and/or chocking material in the space. Optionally, the unblocking comprises unblocking the outboard end of the overboard pipe after the providing adhesive and/or chocking material in the space. Optionally, the unblocking comprises detaching, or removing, the cover from the outboard end of the overboard discharge pipe.

Optionally, the tubular insert comprises a tube that defines a flow path along which a fluid, such as washwater, is flowable from a fluid system, such as a scrubber, of the vessel in use, and a passage through a circumferential wall of the tube, the passage fluidically connecting the flow path with the space; and wherein the providing comprises passing the adhesive and/or chocking material along the passage.

This may allow the adhesive and/or chocking material to be provided in a controlled manner. For instance, the inboard and outboard ends of the space may be blocked, so that the adhesive and/or chocking material is passed into the space along the passage and is contained within the space by the blocked inboard and/or outboard ends of the space.

Optionally, the tubular insert comprises plural such passages. This may allow for quicker provision and/or more even distribution of the adhesive and/or chocking material in the space. Optionally, the passages are circumferentially spaced apart around the tube

Optionally, the passage comprises a connector, and the method comprises connecting a hose to the connector to supply the adhesive and/or chocking material to the passage. Optionally, after providing the adhesive and/or chocking material in the space, the method comprises detaching the hose from the tubular insert, such as by cutting the connector. Optionally, the method comprises allowing the adhesive and/or chocking material to set, such as to cure and/or harden. Optionally, the detaching the hose is performed after the adhesive and/or chocking material has set or hardened.

Optionally, the method further comprises locating a sleeve between the tubular insert and the overboard discharge pipe at an inboard end portion of the overboard discharge pipe.

Optionally, the locating the sleeve comprises inserting the sleeve into the overboard discharge pipe from an inboard end of the overboard discharge pipe. Optionally, the method comprises removing a valve from the inboard end of the overboard discharge pipe, prior to the inserting the sleeve into the overboard discharge pipe.

Optionally, the sleeve encircles the tubular insert and the overboard discharge pipe encircles the tubular insert. Optionally, the sleeve has a flange for abutting an end of the overboard discharge pipe. Optionally, an outer surface of the sleeve is spaced from an interior surface of the overboard discharge pipe.

Optionally, the method comprises using a locator jig to locate the tubular insert and/or the sleeve relative to the overboard discharge pipe. By using the locator jig, components of the overboard discharge assembly may be more easily and reliably located, such as aligned, relative to one another before providing the adhesive and/or chocking material in the space. Optionally, the locator jig comprises the cover jig discussed above.

Optionally, the sleeve is made from a corrosion-resistant material. Optionally, the sleeve is made from an electrically conductive material. Optionally, the sleeve is made from a metal or a metal alloy, such as an austenitic stainless steel. An example is the stainless steel having the trade name 254 SMO™. Another example is a nickel-chromium-based alloy. In some examples, the sleeve is made from a non-metallic material, such as a polymer or an epoxy resin, such as glass-fibre reinforced epoxy (GRE), or a vinyl ester.

Optionally, the overboard discharge pipe is made from an electrically conductive material. Optionally, the overboard discharge pipe is made from a metal or a metal alloy, such as mild steel. Optionally, the overboard discharge pipe is made from a dissimilar material to that of the sleeve. For example, the overboard discharge pipe and the sleeve may be made from dissimilar electrically conductive materials. Optionally, the tubular insert is formed from a corrosion-resistant material. For example, the tubular insert may be formed from an epoxy resin, such as a glass-fibre reinforced epoxy (GRE) material, or from a vinyl ester.

According to a second aspect of the present invention, there is provided a tubular insert for insertion in an overboard discharge pipe of a vessel, the tubular insert comprising: a tube defining a flow path along which a fluid is flowable from a fluid system of the vessel, in use; and a passage through a circumferential wall of the tube, the passage fluidically connecting the flow path with an outer surface of the tube, whereby, during installation of the tubular insert in the overboard discharge pipe, adhesive and/or chocking material is passable from the flow path via the passage to the outer surface of the tube for adhering and/or chocking the outer surface of the tube in the overboard discharge pipe.

Optionally, the flow path is for overboard discharge from the vessel. Optionally, the fluid system is a scrubber. Optionally, the overboard discharge pipe is a scrubber outlet pipe. Optionally, the fluid flowable along the flow path is washwater from the scrubber.

In this way, the adhesive and/or chocking material may be provided in a space between the outer surface of the tube and an interior surface of the overboard discharge pipe in a controlled manner. For instance, axial ends of the space may be blocked so that the adhesive and/or chocking material can be passed into the space along the passage to be contained within the space by the blocked axial ends of the space.

Optionally, the tubular insert comprises plural such passages. This may allow for quicker and/or more even passing of the adhesive and/or chocking material to the outer surface of the tube. Optionally, the passages are circumferentially spaced apart around the tube. Optionally, the or each passage is spaced from an axial end of the tube, such as an inboard axial end of the tube when inserted in the overboard discharge pipe. Optionally, the or each passage is spaced from the axial end of the tube by at least a distance equal to a radius of the tube. In this way, a valve having a radius equal to or less than the radius of the tube, and located proximal to the inboard axial end of the tube when the tube is inserted in the overboard discharge pipe, may articulate within the tube without interfering with the or each passage.

Optionally, the tubular insert comprises a connector to which a hose is connectable to supply the adhesive and/or chocking material to the passage. Optionally, the connector comprises a screw thread. Further optionally, the screw thread is a male screw thread.

Optionally, the tube is an electrically insulative tube. Further optionally, the electrically insulative tube is formed from a corrosion-resistant material. For example, the tube may be formed from an epoxy resin, such as a glass-fibre reinforced epoxy (GRE) material, or from a vinyl ester.

Optionally, the tube comprises one or more protrusions at an outer surface thereof. The, or each, protrusion may be a raised portion of the outer surface of the tube. That is, the, or each, protrusion may be integral with other portions of, or the rest of, the tube. Optionally, the, or each, protrusion is a discrete part provided on the outer surface of the tube, such as by bonding to the outer surface of the tube. Optionally, the, or each, protrusion is an elongate protrusion extending circumferentially or longitudinally along at least a part of the outer surface of the tube. The, or each, protrusion may extend along a full circumference or length of the tube, or may extend only partially along the full circumference or length of the tube. In other examples, the, or each, protrusion is arranged at the outer surface of the tube in any other suitable way. The, or each, protrusion may help to align the tube within the overboard discharge pipe, such as centrally within the overboard discharge pipe, during assembly to provide a space between the tube and the overboard discharge pipe.

Optionally, the tubular insert has a density of greater than 1000 kg/m³ at 4 C and atmospheric pressure.

This may help a person to manhandle the tubular insert, particularly in water such as seawater/saltwater.

Optionally, the density is greater than 1020 kg/m³ at 4 C and atmospheric pressure. Further optionally, the density is greater than 1030 kg/m³ at 4 C and atmospheric pressure.

Optionally, the tubular insert comprises a closure at least partially blocking the flow path at an axial end portion of the tube. Optionally, the closure only partially blocks the flow path. Alternatively, the closure fully blocks the flow path.

According to a third aspect of the present invention, there is provided a kit of parts for use in repairing or providing an overboard discharge outlet, such as a scrubber outlet, of a vessel, wherein the kit of parts comprises the tubular insert according to the second aspect.

Optionally, the kit of parts comprises the adhesive and/or chocking material. Optionally, the kit of parts comprises the hose for connection to the connector.

Optionally, the kit of parts comprises a cover for blocking an overboard outlet in a hull of a vessel, to which overboard outlet the overboard discharge pipe is fluidically connected, in use. Optionally, at least a portion of the cover is flexible, or resilient, so that the cover better conforms to the overboard outlet or hull, in use. Optionally, the tubular insert comprises the closure discussed above, and the kit of parts comprises a mechanism by which the cover is connectable to the closure to help retain the cover in position relative to the overboard outlet or hull, in use. Optionally, the mechanism comprises the cover jig discussed above.

Optionally, the kit of parts comprises a sleeve for encircling the tubular insert when the tubular insert is in the overboard discharge pipe. Optionally, the sleeve has a flange for abutting an end of the overboard discharge pipe. Optionally, the kit of parts comprises the locator jig discussed above.

Optionally, the kit of parts comprises one or more flotation devices for attaching to the tubular insert to increase a buoyancy of the tubular insert.

According to a fourth aspect of the present invention, there is provided an overboard discharge assembly comprising an overboard discharge pipe and the tubular insert according to the second aspect located in the overboard discharge pipe.

According to a fifth aspect of the present invention, there is provided a vessel comprising the overboard discharge assembly according to the fourth aspect.

Optionally, the vessel is a marine vessel.

### BRIEF DESCRIPTION OF DRAWINGS

Embodiments of the invention will now be described, by way of example only, with reference to the accompanying drawings, in which:

FIG. 1 shows a schematic side view of an example marine vessel 1;

FIG. 2 shows a flow chart of an example method;

FIGS. 3A to 3G show respective schematic cross-sectional views of an example scrubber outlet assembly being assembled according to the example method;

FIG. 4 shows a schematic cross-sectional view of an example assembled scrubber outlet assembly; and

FIGS. 5A and 5B show respective perspective and top-down schematic views of an example tubular insert.

### DETAILED DESCRIPTION

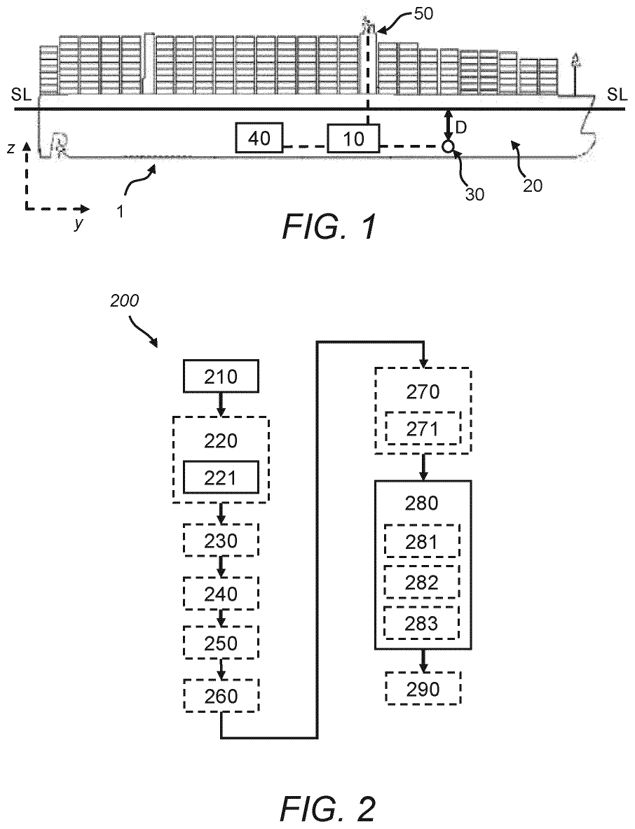

FIG. 1 shows a schematic side view of an example of a marine vessel 1 according to an example. In this example, the marine vessel 1 is a container ship. In other examples, the marine vessel 1 is another form of cargo vessel, such as a tanker, a dry-bulk carrier or a reefer ship, or a passenger vessel. In other examples, the marine vessel is any other water-going vessel, such as a tugboat, or a recreational boat, such as a yacht. In other examples, the vessel is other than a marine vessel, such as a riverboat or another type of inland vessel.

The marine vessel 1 comprises a scrubber 10, a hull 20, a scrubber outlet 30, an engine 40, and a stack 50. Exhaust gases from the engine 20 are passed through the scrubber 10 towards the stack 50, to be emitted into the atmosphere. The scrubber is an open-loop scrubber, configured to spray sea water into the exhaust gases to remove pollutants from the exhaust gases. Specifically, the scrubber is configured to remove SOx from the exhaust gases, though in some examples it is configured to remove nitrogen oxides (NOx), soot, or other products of combustion from the exhaust gases.

Contaminated effluent from the scrubber, referred to herein as “washwater”, is passed to the scrubber outlet 30 to be expelled though the hull 20 into the ocean surrounding the marine vessel 1. The scrubber outlet 30 is located below sea level, which is indicated by the line labelled “SL” in FIG. 1, in use. The distance of the scrubber outlet 30 below sea level, indicated by the arrow D in FIG. 1, is up to 10 metres. In some examples, the distance D is up to 1 metre, up to 2 metres, up to 5 meters, or up to 20 metres below sea level. It will be understood that a distance of the scrubber outlet 30 below sea level may depend on the size of the marine vessel 1, and/or a mass of the marine vessel 1, in use.

The washwater comprises sulphuric acid, which is extracted from the exhaust gases in the scrubber 10. The washwater is also at an elevated temperature, as compared to the temperature of the surrounding ocean, due to the heat of the exhaust gases passing through the scrubber 10. Thus, materials exposed to the washwater are at a greater risk of corrosion than the materials exposed to, say, sea water, or fresh water. However, it will be understood that other materials such as seawater or freshwater, particularly warm seawater or freshwater, may still present a risk of corrosion. As such, it will be appreciated that the present invention, although described herein in relation to a scrubber outlet 30 of a scrubber 10 of a marine vessel 1, may be applied to any suitable overboard discharge outlet or discharge assembly of any suitable vessel, such as a ballast water outlet for discharging ballast water from ballast tanks of the vessel. That is, the present invention may be applied to any suitable vessel, which may or may not comprise a scrubber 10.

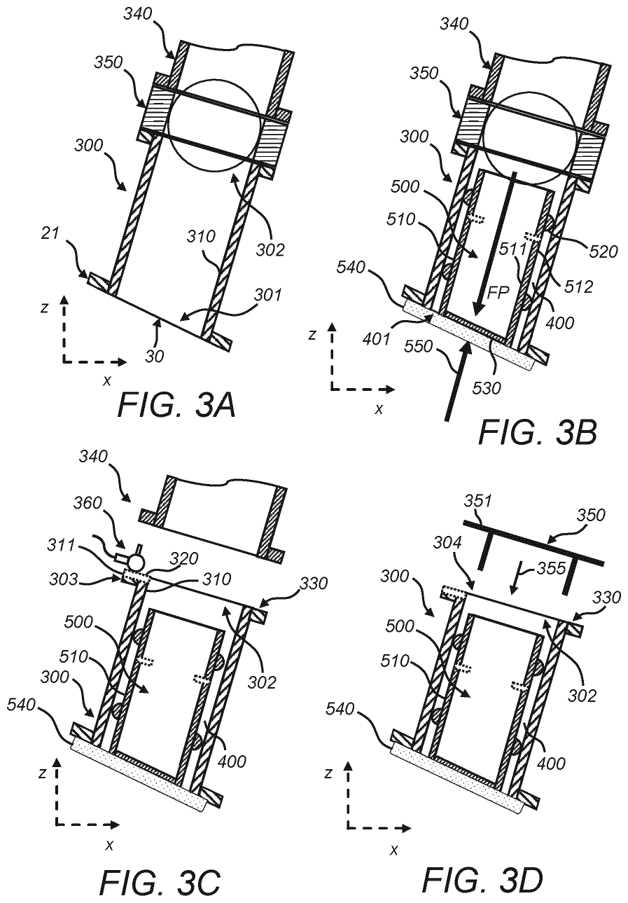

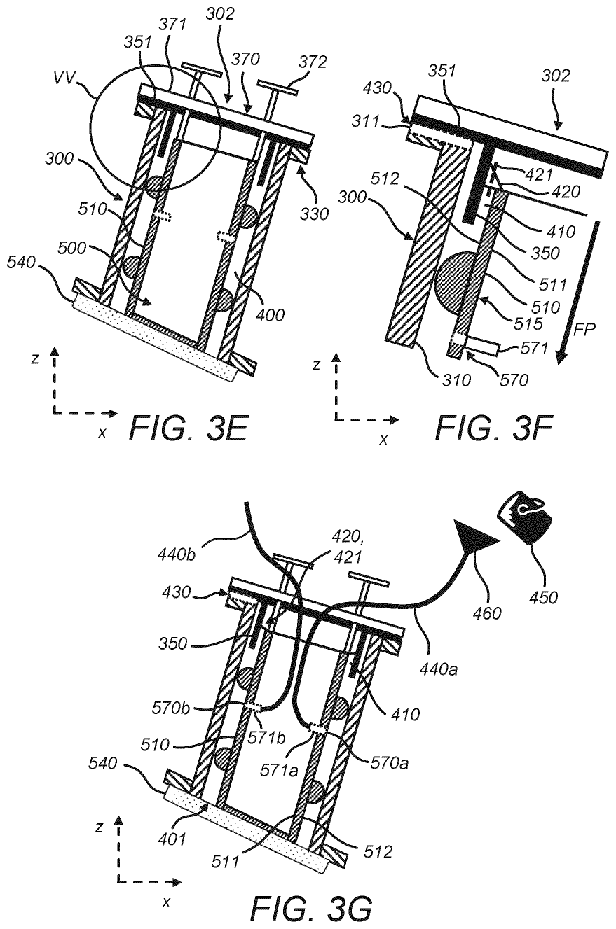

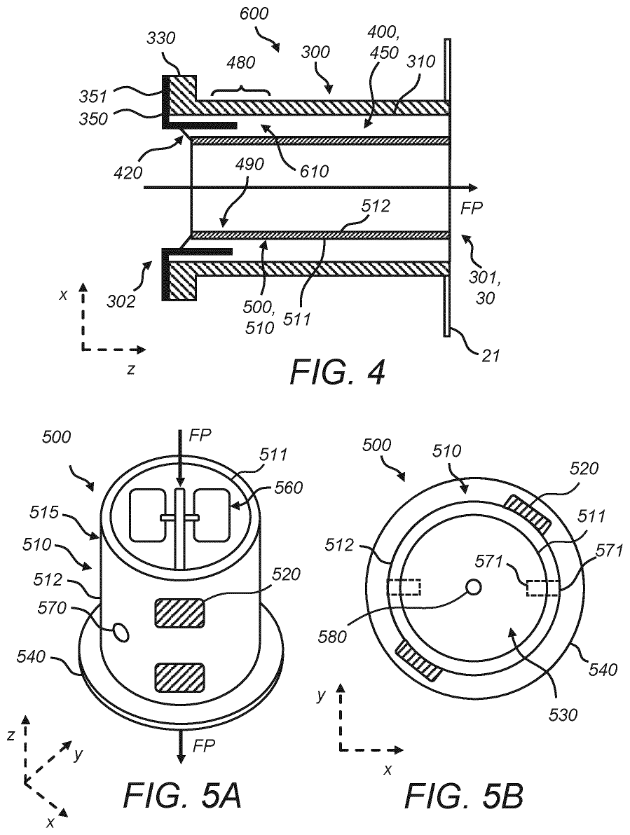

FIG. 2 shows an example method 200 of assembling a vessel overboard discharge assembly, specifically a scrubber outlet assembly associated with the scrubber outlet 30 of the marine vessel 1. The method 200 will be described with reference to FIGS. 3A to 3G, which illustrate various stages of the assembly procedure. The resulting overboard discharge assembly, specifically a scrubber outlet assembly 600, will be described in more detail hereinafter with reference to FIG. 4.

An example scrubber outlet pipe 300 or, more broadly, an “overboard discharge pipe” 300, is shown in FIG. 3A. The scrubber outlet pipe 300 is in fluid communication, at an outboard end 301 of the scrubber outlet pipe 300, with the scrubber outlet 30, and, at an inboard end 302 of the scrubber outlet pipe 300, with a valve 350. The scrubber outlet 30 is formed in a hull part 21 of the hull 20 of the marine vessel 1. The valve 350 is operable to control a flow of washwater from the scrubber 10, such as from a scrubber conduit 340 fluidically connected between the valve 350 and the scrubber 10, and through the scrubber outlet 30 via the scrubber outlet pipe 300. In some examples, the valve 350 is not present, or is located further upstream of the scrubber outlet pipe 300 and/or scrubber conduit 340.

An interior surface 310 of the scrubber outlet pipe 300 comprises a first electrically conductive material. In the present example, this is by the scrubber outlet pipe 300 being made from the first electrically conductive material. The first electrically conductive material is the same as that of the hull part 21, in this case mild steel, which may facilitate a connection of the scrubber outlet pipe 300 to the hull part 21, such as by welding. In other examples, the first electrically conductive material is any other suitable material. In some examples, the interior surface 310 is coated with a corrosion-resistant coating, such as a non-electrically conductive coating, such as a vinyl ester coating. A similar coating may be applied to the hull part 21.

The coating may not entirely cover the interior surface, and/or may degrade with use, exposing a part of the electrically conductive interior surface of the scrubber outlet pipe 300 to the washwater flowing therethrough, in use. That is, the scrubber outlet pipe 300 may become corroded with use. In this way, in some examples, the method 200 of assembling the scrubber outlet assembly 600 described hereinafter is a method of repairing, or maintaining, the scrubber outlet pipe 300.

Returning to FIG. 2, broadly speaking, the method 200 comprises inserting 210, into the scrubber outlet pipe 300, a tubular insert 500, which will be described in more detail hereinafter in relation to FIG. 5. The inserting 210 the tubular insert defines a space between the tubular insert 500 and the scrubber outlet pipe 300. The method 200 comprises blocking 221 an outboard opening into the space at an outboard end of the space, and providing 280 in the space an adhesive and/or chocking material for adhering and/or chocking the tubular insert 500 in the scrubber outlet pipe 300.

The method 200 is now described in further detail with reference to FIGS. 3B to 3G. Any reference numeral shown in any one of FIGS. 3A to 3G may be omitted from any other of FIGS. 3A to 3G, for clarity; however, it will be appreciated that features represented by such reference numerals are consistently presented in the figures. That is, a feature presented in one of FIGS. 3A to 3G may be presented in any other of FIGS. 3A to 3G with or without a reference numeral.

Turning now to FIG. 3B, as noted hereinbefore, the method 200 comprises inserting 210 the tubular insert 500 into the scrubber outlet pipe 300, specifically from the outboard end 301 of the scrubber outlet pipe 300 as shown by the arrow labelled 550 in FIG. 3B. The tubular insert 500 is shown in more detail in FIGS. 5A and 5B, and comprises a tube 510 defining a flow path (FP) along which washwater is flowable overboard from the vessel, from the scrubber 10, in use. In other words, the flow path is for overboard discharge from the vessel. An interior surface 511 of the tube 510 comprises an electrically insulative material. In the present example, this is by the tube 510 being made from a corrosion-resistant material, specifically glass-fibre reinforced epoxy (“GRE”). In other examples, the tube 510 is made of, and/or coated with, any other suitable corrosion-resistant material, such as a vinyl ester.

In other examples, the tubular insert 500, or a part thereof, such as the tube 510, may be inserted from the inboard end 302 of the scrubber outlet pipe 300. This may require removal of the valve 350 and/or the scrubber conduit 340, or a portion thereof. Therefore, by inserting the tubular insert 500 from the outboard end 301, no or fewer components may need to be removed from the inboard end 302.

It will be understood that the method 200 may be performed when the outboard end 301 of the scrubber outlet pipe 300 is submerged. In some such instances, the inserting 210 the tubular insert 500 may comprise using one or more flotation devices 560, as illustrated in FIG. 5A, to increase a buoyancy of the tubular insert. The buoyancy of the one or more flotation devices may be adjustable so as to improve an ease of handling the tubular insert 500 during the insertion 210 of the tubular insert. In some such examples, the method 200 comprises removing the flotation devices 560 when the tubular insert 500 has been inserted 210 in the scrubber outlet pipe 300. It will be understood that the flotation devices 560 can be removed at any suitable point during the assembly 200.

It can be seen from FIG. 3B that a space 400 is defined between the tubular insert 500 and the scrubber outlet pipe 300. The space 400 extends circumferentially around the tubular insert 500, specifically around the tube 510. In the illustrated example, an outer surface 512 of the tube 510 comprises protrusions 520. The protrusions 520 help to align the tubular insert 500 within the scrubber outlet pipe 300, such as centrally within the scrubber outlet pipe 300, to provide the space 400 between the tube 510 and the scrubber outlet pipe 300. The protrusions 520 will be described in more detail hereinafter with reference to FIGS. 5A and 5B.

The method 200 comprises blocking 221 an outboard opening 401 into the space 400 at an outboard end of the space 400, which here is at the outboard end 301 of the scrubber outlet pipe 300, after the tubular insert 500 is inserted into the pipe 300. Specifically, in the illustrated example, as shown in FIG. 2, the method 200 comprises blocking 220 the outboard end 301 of the scrubber outlet pipe 300, such as by blocking 220 the outlet 30 in the hull part 21. The blocking 220 the outboard end 301 of the scrubber outlet pipe 300 comprises the blocking 221 the outboard opening 301 into the space 400. In some examples, the blocking 220 the outboard end 301 of the scrubber outlet pipe and/or the blocking 221 the outboard opening 401 into the space 400 comprises sealing the respective outboard end 301 and/or outboard opening 401. In some examples, such as some examples in which the tubular insert 500 is inserted from the inboard end 302 of the scrubber outlet pipe 300, the blocking 220, 221 the outboard end 301 of the scrubber outlet pipe 300 and/or the outboard opening 401 of the space 400 occurs before or currently with the insertion of the tubular insert 500.

In the illustrated example, the method 200 comprises using a cover 540 to block 220 the outboard end 301 of the scrubber outlet pipe 300 in such a way that the cover blocks 221 the outboard opening 401 into the space 400 at the outboard end of the space 400. In the illustrated example, the cover 540 is connected to the tubular insert 500. Specifically, the cover 540 is fixed to a closure 530 at an outboard end of the tube 510. In other examples, the cover 540 is located and/or held in place in any suitable way, such as by using an adhesive and/or a cover jig (not shown). In some examples, such a cover jig may comprise a portion secured, or securable, at an inboard end of the scrubber outlet assembly 600, such as at an inboard end of the tubular insert 500 or the scrubber outlet pipe 300, and a portion secured, or securable, to the cover 540. The cover 540 is described in more detail hereinafter with reference to FIGS. 5A and 5B.

Returning to FIG. 2, when the method 200 is performed with the outboard end 301 of the scrubber outlet pipe 300 submerged, the method 200 further comprises draining 230, such as fully or only partially draining, the space 400 and/or the scrubber outlet pipe 300 after blocking 220, 221 the outboard end 301 of the scrubber outlet pipe 300 and/or the outboard opening 401 of the space 400. The draining 230 may be performed using dedicated drain valves provided to drain the scrubber outlet pipe 300, the valve 350 and/or the scrubber conduit 340, or in any other suitable way. In examples where the method 200 is performed in a dry dock, the scrubber outlet pipe 300 may be drained prior to blocking 220, 221 the outboard end 301 of the scrubber outlet pipe 300 and/or the outboard opening 401 of the space 400.

In the illustrated example, the method 200 further comprises removing 240 the valve 350. The removing 240 the valve 350 may be performed before, during, or after the draining 230 the scrubber outlet pipe 300. For example, the draining 230 may comprise initially draining only the scrubber conduit 340 and/or the valve 350. The valve 350 may then be removed 240 and the scrubber outlet pipe 300 drained 230 from the inboard end 302 of the scrubber outlet pipe 300.

In other examples, the removing 240 the valve 350 may be performed before or during the inserting 210 of the tubular insert 500 and/or before or during the blocking 221 the outboard opening 401 into the space 400.

In some examples, although not shown in the figures, following removal of the valve 350, the tubular insert 500, or a part thereof, such as the tube 510, may be moved out of the scrubber outlet pipe 300 in an inboard direction, such as into the scrubber conduit 340, or removed through a space formed by removal 240 of the valve 350. This may provide improved access to the interior surface 310 of the scrubber outlet pipe 300, such as to allow the scrubber outlet pipe 300 to be cleaned and/or scoured. This may be particularly desirable where the scrubber outlet pipe 300 is corroded and is being repaired or maintained.

The method 200 further comprises, with reference now to FIG. 3C, forming 250 a groove 320 in an inboard portion 330 of the scrubber outlet pipe 300. The inboard portion 330 is here a flange portion 330 for connection to the valve 350, though in some examples it may not be a flange portion 330 as such. The groove 320 extends from the interior surface 310 of the scrubber outlet pipe 300 to an outer surface 311 of the scrubber outlet pipe 300, which here is an outer portion 311 of the flange portion 330. The forming 250 here comprises cutting the groove 320 into the flange portion 330, such as using any suitable cutting tool 360. In other examples, the forming 250 comprises drilling, grinding, or forming 250 the groove 320 in any other suitable way. In the illustrated example, the scrubber outlet pipe 300 is inclined and the groove 320 is formed 250 in, such as cut into, an uppermost portion 303 of the inboard end 302 of the scrubber outlet pipe 300. In other examples, the method 200 comprises forming 250 the groove 320 in any other suitable location at the inboard end 302 of the scrubber outlet pipe 300. In some examples the method 200 comprises forming 350 plural grooves 320 in the inboard portion 330 of the scrubber outlet pipe 300. In some examples, the forming 250 comprises forming 250, such as by cutting, drilling, grinding, or any other suitable method of forming 250, a channel or conduit between the interior surface 310 and any suitable exterior portion of the scrubber outlet pipe 300, thereby to fluidically connect an interior of the scrubber outlet pipe 300 with an exterior of the scrubber outlet pipe 300. Specifically, the channel or conduit, such as the groove 250, forms at least a part of a vent hole from the space 400 defined between the tubular insert 500 and the scrubber outlet pipe and an exterior of the scrubber outlet assembly 600, as will be described in more detail hereinafter with reference to FIG. 3F.

Turning now to FIG. 3D, the method 200 further comprises locating 260 a sleeve 350 between the tubular insert 500 and the scrubber outlet pipe 300 at an inboard end portion 304, located at the inboard end 302, of the scrubber outlet pipe 300. Specifically, in the illustrated example, the locating 260 the sleeve 350 comprises inserting 260 the sleeve 350 into the scrubber outlet pipe 300 from the inboard end 302 of the scrubber outlet pipe, as shown by the arrow labelled 355 in FIG. 3D. In some examples, though not illustrated here, before inserting 260 the sleeve, the method 200 comprises applying adhesive to the inboard end 302 of the scrubber outlet pipe 300, specifically to the flange portion 330. In some examples, the adhesive is provided to fix and/or seal the sleeve 350 to the inboard end 302 of the scrubber outlet pipe 300, such as to the flange portion 330. In some such examples, the groove 320 should be kept free of the adhesive.

FIG. 3E shows the sleeve 350 after having been located 260 between the tubular insert 500 and the scrubber outlet pipe 300. The sleeve 350 encircles the tubular insert 500. Specifically, the sleeve 350 encircles an inboard end of the tube 510 of the tubular insert 500. The sleeve 350 comprises a flange 351 for abutting the inboard end 302 of the scrubber outlet pipe 300, such as for abutting the flange portion 330 of the scrubber outlet pipe 300.

In some examples, the method 200 comprises using a locator jig 370 to locate the tubular insert 500 and the sleeve 350 relative to the scrubber outlet pipe 300. Specifically, the locator jig 370 comprise a plate portion 371 that is fixed, such as bolted or clamped, to the flange portion 330 of the scrubber outlet 300, such as to at least partially sandwich the flange 351 of the sleeve 350 between the locator jig 370 and the flange portion 330. In the illustrated example, the locator jig 370 comprises handles 372 for locating the tubular insert 500 in the scrubber outlet pipe 300. Specifically, the handles 372 pass through the plate portion 371, and the handles 372 and the plate portion 371 comprise correspondingly engaging threads. In some examples, the method 200 comprises screwing the handles 372 into the plate portion 371, towards the tubular insert 500, to cause a retaining force to be exerted on the tubular insert 500. The retaining force is a longitudinal force to retain the tubular insert 500 within the scrubber outlet pipe 300 between the cover 540 and the inboard end 302 of the scrubber outlet 300.

In some examples, the locator jig 370 comprises, or is a part of, the cover jig described hereinbefore. That is, in some examples, the cover 540 is connected, or connectable, to the locator jig 370 to hold the cover 540 in place. In some examples, the locator jig 370 is not used, and the sleeve 350 is located and/or fixed to the inboard end 302 of the scrubber outlet pipe 300 in any other suitable way, such as by bolting or clamping the sleeve 350, such as the flange 351 of the sleeve 350, to the inboard end 302 of the scrubber outlet pipe 300, such as to the flange portion 330 of the scrubber outlet pipe 300.

FIG. 3F shows an expanded schematic view of the region labelled VV in FIG. 3E. It can be seen that the sleeve 350 in the illustrated example is spaced from the interior surface 310 of the scrubber outlet pipe 300. The sleeve 350 is also spaced from the outer surface 512 of the tube 510 of the tubular insert 500. In this way, the sleeve 350 and the tube 510 together define an inboard opening 410 into the space 400. That is, the inboard opening 410 is a circumferential opening into the space 400. In other examples, the sleeve 350 is in contact with either one or both of the interior surface 310 of the scrubber outlet pipe 300 and the outer surface 512 of the tube 510.

FIG. 3F also shows the groove 311 that is formed 250 into the flange portion 230 in more detail. The groove 311 forms at least a part of a first vent hole 430. Specifically, the first vent hole 430 is defined by the groove 311 and the flange 351 of the sleeve 350. The first vent hole 430 opens into the space 400 at a region between the sleeve 350 and the interior surface 310 of the scrubber outlet pipe 300. In other examples, the first vent hole 430 may be formed in any other suitable way, such as by forming a hole in the scrubber outlet pipe 300 in proximity to the inboard end 302 of the scrubber outlet pipe 300.

The method 200 further comprises blocking 270 the inboard opening 410 in the space 400. Specifically, the blocking 270 the inboard opening 410 comprises applying a blocking material, such as a glue, a putty, a sealant, or any other suitable blocking material, to form a blockage 420 in the inboard opening 410. In the illustrated example, the blocking 270 further comprises providing 271 a second vent hole 421 into a region between the sleeve 350 and the tube 510. The second vent hole 421 illustrated by the dashed line in FIG. 3F is a vent hole 421 in the blockage 420, though in other examples the second vent hole 412 may be in the sleeve 350 and/or the tube 510. The second vent hole 421 is formed by drilling, punching, or otherwise forming the second vent hole 421 in the blockage 420, sleeve 350 or tube 510. In some examples, a tubular vent (not shown) is provided in the second vent hole 421, such as by applying the blocking material around the tubular vent. In some examples, the tubular vent is transparent. In other examples, the tubular vent is removed following the blocking 270 the inboard opening 410 to form the second vent hole 421.

The tubular insert 500, as best shown in FIG. 3F, comprises a passage 570 through a circumferential wall 515 of the tube 510. The passage 570 fluidically connects the flow path FP with the space 400. The passage 570 comprises a connector 571 for connecting the passage 570 to a hose, as will be described hereinafter. More specifically, as best shown in FIGS. 5A and 5B described hereinafter, the tubular insert 500 comprises plural such passages 570 circumferentially spaced around the tube 510, each passage 570 comprising a respective connector 571.

Turning now to FIG. 3G, as noted hereinbefore, the method 200 comprises providing 280 in the space 400 an adhesive and/or chocking material, herein referred to with the reference numeral 450. In the illustrated example, the providing 280 the adhesive 450 and/or chocking material 450 in the space 400 comprises connecting 281 a first conduit 440a, such as a hose 440a, to a first one of the passages 570a, specifically to a respective first one of the connectors 571a. The first conduit 440a comprises a funnel 460. The adhesive 450 and/or chocking material 450 is supplied to the space 400 via the first conduit 440a and the first passage 570a, such as by pouring the adhesive 450 and/or chocking material 450 in the funnel 460. In other examples, the adhesive and/or chocking material is provided in the space 400 in any other suitable way, such as from a lower end of the scrubber outlet pipe 300, such as the outboard end 301 of the scrubber outlet pipe 300 in the present example. That is, in some examples, the or each passage 470 may be located at any longitudinal location on the tube 510. In other examples, the adhesive 450 and/or chocking material 450 is provided via the outboard opening 401 or the inboard opening 410 into the space 400 in any suitable way.

It will be understood that the adhesive 450 and/or chocking material 450 will pass through the space 400 to fill the space 400. As it does so, air may initially be vented from the space 400 via a second conduit 440b, or hose 440b, connected to a second one of the passages 470b via a respective second one of the connectors 471b. Air may also be vented from either or both of the first and second vent holes 421, 430. Eventually, the adhesive and/or chocking material may pass through the second conduit 440b, providing a visual indication of an amount of adhesive 450 and/or chocking material 450 in the space 400. In some examples, the second conduit 440b can be used for filling the space 400 with adhesive and/or chocking material in tandem with the first conduit 440a.

Providing the second vent hole 421 may allow the adhesive 450 and/or chocking material 450 to fill the region between the sleeve 350 and the tube 510, which may otherwise contain a trapped air bubble. The adhesive and/or chocking material may then pass through the second vent hole 421, such as through a tubular vent in the second vent hole 241 as described hereinbefore. This may provide a visual indication that the adhesive and/or chocking material has filled the region between the sleeve 450 and the tube 510, particularly when the tubular vent is transparent. Once the adhesive 450 and/or chocking material 450 has passed through the second vent hole 421, the method 200 may comprise plugging the second vent hole 421 in any suitable way to prevent the adhesive and/or chocking material from passing through the second vent hole 421.

Finally, the adhesive 450 and/or chocking material 450 may pass through the first vent hole 430 which, as described hereinbefore, is located at an upper portion of the space 400. This may provide a visual indication that the space 400 has been completely filled.

It will be understood that an opening of the first conduit 440a, such as the funnel 460, and an opening of the second conduit 440b, should be located above a desired fill level of the adhesive 450 and/or chocking material 450 to ensure that the adhesive 450 and/or chocking material 450 remains within the space 400. In the illustrated example, this is by locating the openings of the first and second conduits 440a, 440b above the first vent hole 430.

Once the space 400 has been filled to the desired level, the providing 280 the adhesive 450 and/or the chocking material 450 comprises allowing 282 the adhesive and/or chocking material to set, such as to cure and/or harden. The method 200 further comprises, before, during, or after the allowing 282 the adhesive 450 and/or chocking material 450 to set, such as to cure and/or harden, detaching 283 the or each conduit 440a, 440b from the tubular insert. In some examples, the detaching 283 comprises cutting the or each respective connector 571a, 571b. In some examples, the cutting comprises smoothing the interior surface of the tube 510 where the or each connector 571a, 571b was located.

The method 200 further comprises, after the providing 280 the adhesive 450 and/or chocking material 450 in the space, unblocking 290 the outboard opening into the space 400. Specifically, in the illustrated example, the unblocking 290 comprises unblocking the outboard end 301 of the scrubber outlet pipe 300 by detaching, or removing, the cover 540 in any suitable way. In some examples, this is by disconnecting the cover 540 from the cover jig, and/or the closure 530 described hereinbefore. In some examples, the unblocking 290 further comprises unblocking the flow path FP, such as by removing the closure 530 in any suitable way.

FIG. 4 shows a side-on cross-sectional schematic view of the scrubber outlet assembly 600 assembled using the method 200 described hereinbefore. Like features shown in FIGS. 3A to 3G are given like reference numerals in FIG. 4.

In the illustrated example, the sleeve 350 is made from a stainless steel having the trade name 254 SMO™. In other examples, the sleeve 350 comprises, or is made from, a different corrosion-resistant material, such as a metal or a metal alloy, such as a different austenitic stainless steel. Another example is a nickel-chromium-based alloy. In other examples, the sleeve 350 comprises, or is made from, a non-metallic material, such as a polymer or an epoxy resin, such as glass-fibre reinforced epoxy (GRE), or a vinyl ester.

In the illustrated example, the scrubber outlet pipe 300 is made from a dissimilar material to that of the sleeve 350. Specifically, the scrubber outlet pipe 300 and the sleeve 350 are made from dissimilar electrically conductive materials. In this example, the scrubber outlet pipe 300 is made from mild steel, but in other examples it could be made from some other metal or metal alloy. As such, a region 480 comprising a part of the sleeve 350 and a part of the scrubber outlet pipe 300 may be susceptible to galvanic corrosion if it were to be in contact with washwater flowing past the sleeve 350 and the scrubber outlet pipe 300 in use. This is due to the proximity of the part of the sleeve 350 and the part of the scrubber outlet pipe 300 in the region 480, which could result in a preferential corrosion of one of the dissimilar materials. In the illustrated example, the sleeve 350 and the scrubber outlet pipe 300 are initially separated by a gap (which is later filled with the adhesive 450 and/or chocking material 450), but in other examples, the sleeve 350 is in contact with the scrubber outlet pipe 300, which may lead to an increased risk of galvanic corrosion in the region 480 in the presence of washwater.

As such, the assembled scrubber outlet assembly 600 comprises a barrier 490 fluidically isolating the region 480 from the flow path FP. The barrier 490 comprises the tube 510 and the adhesive 450 and/or chocking material 450 in the space 400. As the tube 510 and the adhesive 450 and/or chocking material 450 are each made from corrosion-resistant and electrically insulative materials, the region 480, as well as the sleeve 350 and the scrubber outlet pipe 300 themselves, are better protected from corrosion in the presence of washwater, or other material, flowing along the flow path FP, in use. Specifically, the adhesive 450 and/or chocking material 450 in the illustrated example is made of an epoxy resin casting compound. It is also resilient to thermal and physical shock. This more reliably holds the tube 510 in the scrubber outlet pipe 300 in the harsh conditions presented by the high temperature washwater, or other material flowing along the flow path FP, in use.

Turning now to FIGS. 5A and 5B, shown are, respectively, a perspective schematic view and a top-down schematic view of the tubular insert 500. The tubular insert 500 comprises the tube 510 defining the flow path (FP) along which fluid is flowable overboard from the vessel, from the scrubber 10 in use. As noted hereinbefore, the tubular insert 500, and particularly the tube 510, comprises and/or is made from GRE. In other examples, the tube 510 comprises any other suitable material, preferably a corrosion resistant and electrically insulative material. In other examples, the tubular insert 500 and/or the tube 510 may comprise an electrically conductive material which is optionally coated with a non-electrically conductive material.

The tubular insert 500 further comprises two passages 570 through a circumferential wall 515 of the tube 510, the passages 570 fluidically connecting the flow path FP with the outer surface 512 of the tube 510. As noted hereinbefore, during installation of the tubular insert 500 in the scrubber outlet pipe 300, the adhesive 450 and/or chocking material 450 is passable from the flow path FP via the passage 570 or passages 570 to the outer surface 512 of the tube 510 for adhering and/or chocking the outer surface 512 of the tube 510 in the scrubber outlet pipe 300. The passages 570 are circumferentially spaced around the tube 510 and comprise respective connectors 571. In this example, the connectors 571 comprise screw threads, and more particularly male screw threads. Optionally, the first and second conduits 440a, 440b described hereinbefore comprise corresponding screw threads, and are connectable to the connectors 571 via the screw threads. In other examples, the connectors 571 may take a different form, such as respective female screw threads.

The tubular insert 500 of the illustrated example comprises a closure 530 at an axial end portion of the tube 510, specifically an axial end portion that will be located at the outboard end 301 of the scrubber outlet pipe 300 in use. The cover 540 is fixed to the closure 530, such as by a bolt 580 or other fixing. In some example, the closure 530 is, or comprises the cover 540. In other examples, the closure 530 is not present, and the cover 540 is fixed to the tube 510 in any other suitable way. In other examples, the cover 540 is provided separately to the tubular insert 500. When provided, the closure 530, and/or the cover 540, fully or partially blocks the flow path FP at the outboard axial end portion of the tube 510. In some examples, at least a portion of the cover 540 is flexible, or resilient, so that the cover 540 better conforms to the scrubber outlet 30 or hull part 21, in use.

The tube 510 in the illustrated example comprises protrusions 520, specifically four protrusions 520, though any other number of protrusions may be present in other examples. The protrusions 520 are raised portions of the outer surface 512 of the tube 510. That is, the protrusions 520 are integral with the tube 510. In other examples, the protrusions 520 are distinct parts provided on the outer surface 512 of the tube 510, such as bonded to the outer surface 512 of the tube 520. The protrusions 520 are elongate and extend circumferentially around a part of the tube 510, though in other examples, the protrusions 520 may be any suitable shape and arranged in any appropriate orientation for a desired alignment of the tubular insert 500 and the scrubber outlet pipe 300. For example, the protrusions 520 may be elongate and oriented in a longitudinal direction of the tube. In some examples, the protrusions are equally circumferentially spaced around the tube 510. In some examples, the protrusions 520 are not present, and the tubular insert 500 is aligned within the scrubber outlet pipe 300 in any other suitable way, such as by using a jig, such as the locator jig 370 described hereinbefore.

In the illustrated example, the tubular insert has a density of greater than 1000 kg/m³ at 4 C and atmospheric pressure. That is, the tubular insert has a density greater than that of water at 4 C, so that it will not naturally float in water. In other examples, the density is greater than 1020 kg/m³ at 4 C and atmospheric pressure, and/or greater than 1030 kg/m³ at 4 C and atmospheric pressure, so that it will not naturally float in seawater. In the illustrated example, the tube 510 comprises a flotation device 560 (which is omitted from FIG. 5B for clarity). The flotation device 560 is provided to increase the buoyancy of the tubular insert 500, such as during insertion of the tubular insert 500 into the scrubber outlet pipe 300. In some examples, a buoyancy of the flotation device 560 is adjustable. In some examples, the tubular insert 500 comprises more than one flotation device 560. In some examples, the or each flotation device is removable, such as when the tubular insert 500 is installed in the scrubber outlet pipe 300. In some examples, the tubular insert does not comprise the flotation device 560. In some such examples, the flotation device 560 may be provided separately and connected to the tubular insert 500.

In some examples, a kit of parts is provided. The kit of parts comprises the tubular insert 500 and is for use in repairing the scrubber outlet pipe 300 or providing a scrubber outlet assembly 600 as described herein. In some examples, the kit of parts comprises: the adhesive and/or chocking material 450; the conduits 440a, 440b; the cover 540; a mechanism by which the cover 540 is connectable to the tube 510 or closure 530, such as the cover jig discussed hereinbefore; the sleeve 350; the locator jig 370; and/or the flotation device 560. It will be appreciated that, in some examples, the kit of parts may comprise any component used in the repair of the scrubber outlet pipe 300 and/or the provision of the scrubber outlet assembly 600 according to the various methods 200 described herein.

Example embodiments of the present invention have been discussed, with particular reference to the examples illustrated. However, it will be appreciated that variations and modifications may be made without departing from the scope of the invention as defined by the appended claims.

1. A method of assembling a vessel overboard discharge assembly, the method comprising:
inserting a tubular insert into an overboard discharge pipe so that a space is defined between the tubular insert and the overboard discharge pipe;
blocking an outboard opening into the space at an outboard end of the space; and
providing in the space an adhesive and/or chocking material for adhering and/or chocking the tubular insert in the overboard discharge pipe.

2. The method of claim 1, wherein the inserting comprises inserting the tubular insert into the overboard discharge pipe from an outboard end of the overboard discharge pipe.

3. The method of claim 1, wherein the blocking occurs after the inserting.

4. The method of claim 2, wherein the method comprises blocking the outboard end of the overboard discharge pipe, and the blocking the outboard end of the overboard discharge pipe comprises the blocking the outboard opening into the space.

5. The method of claim 4, comprising using a cover to block the outboard end of the overboard discharge pipe, in such a way that the cover blocks the outboard opening into the space at the outboard end of the space.

6. The method of claim 5, wherein at least a portion of the cover is flexible, or resilient, so that the cover better conforms to the outboard end of the overboard discharge pipe and/or to the outboard opening into the space.

7. The method of claim 4, comprising at least partially draining the space or the overboard discharge pipe after the blocking the outboard end of the overboard discharge pipe.

8. The method of claim 1, wherein the inserting is performed when an outboard end of the overboard discharge pipe is submerged.

9. The method of claim 8, comprising using one or more flotation devices to increase a buoyancy of the tubular insert during the inserting of the tubular insert.

10. The method of claim 1, comprising blocking an inboard opening into the space at an inboard end of the space.

11. The method of claim 1, comprising providing a vent hole to allow air and/or adhesive and/or chocking material to be vented when providing the adhesive and/or chocking material in the space.

12. The method of claim 1, comprising unblocking the outboard opening into the space after the providing adhesive and/or chocking material in the space.

13. The method of claim 1, wherein the tubular insert comprises a tube that defines a flow path along which a fluid is flowable from a fluid system of the vessel in use, and a passage through a circumferential wall of the tube, the passage fluidically connecting the flow path with the space; and
wherein the providing comprises passing the adhesive and/or chocking material along the passage.

14. The method of claim 1, wherein the method further comprises locating a sleeve between the tubular insert and the overboard discharge pipe at an inboard end portion of the overboard discharge pipe.

15. The method of claim 14, wherein the sleeve encircles the tubular insert and the overboard discharge pipe encircles the tubular insert.

16. A tubular insert for insertion in an overboard discharge pipe of a vessel, the tubular insert comprising:
a tube defining a flow path along which a fluid is flowable from a fluid system of the vessel, in use; and
a passage through a circumferential wall of the tube, the passage fluidically connecting the flow path with an outer surface of the tube, whereby, during installation of the tubular insert in the overboard discharge pipe, adhesive and/or chocking material is passable from the flow path via the passage to the outer surface of the tube for adhering and/or chocking the outer surface of the tube in the overboard discharge pipe.

17. The tubular insert of claim 16, wherein the tubular insert has a density of greater than 1000 kg/m³ at 4 C and atmospheric pressure.

18. A kit of parts for use in repairing or providing an overboard discharge outlet of a vessel, wherein the kit of parts comprises the tubular insert according to claim 16.

19. An overboard discharge assembly comprising an overboard discharge pipe and the tubular insert according to claim 16 located in the overboard discharge pipe.

20. A vessel comprising the overboard discharge assembly according to claim 19.
